(19) United States
(12) Patent Application Publication
(10) Pub. No.: US 2012/0189502 A1
(43) Pub. Date: Jul. 26, 2012

(54) BOTTOM-LOADING WATER COOLERS WITH OZONE STERILIZING DEVICES

(76) Inventor: George Yui, Toronto (CA)

(21) Appl. No.: 13/438,024

(22) Filed: Apr. 3, 2012

Related U.S. Application Data
(63) Continuation-in-part of application No. 12/395,633, filed on Feb. 28, 2009.

(30) Foreign Application Priority Data
Jul. 11, 2008 (CN) 2008-20121255

(51) Int. Cl. B01J 19/08

(52) U.S. Cl. 422/168; 422/186.07

(57) ABSTRACT

Devices and methods for sterilizing bottled water coolers (and water dispensed from such coolers) are disclosed. More specifically, a bottled water cooler is disclosed that includes a water bottle, a cabinet, a cold tank, a bottle receptacle located in the bottom half of the cabinet that is configured to receive the water bottle, and an ozone generator. The ozone generator is capable of dispensing ozone gas within the water bottle and/or cold tank, such that the ozone gas will be effective to sterilize the interior portions of the water bottle and/or cold tank (and the water contained therein).

### CROSS-REFERENCE TO RELATED APPLICATIONS

This application is a continuation-in-part application of U.S. patent application Ser. No. 12/395,633, filed on Feb. 28, 2009, which claims priority to, and incorporates by reference, Chinese Patent Application Number 2008-20121255, filed Jul. 11, 2008, under 35 U.S.C. §119(a).

### FIELD OF THE INVENTION

The present invention relates generally to the field of bottled water coolers and, more particularly, to devices and methods for sterilizing bottled water coolers and water dispensed therefrom.

### BACKGROUND OF THE INVENTION

The demand for clean and healthy drinking water is increasing dramatically. The rapid growth in population, and standards of living, across the globe are fueling an incredible demand for devices and methods that enable drinking water, and the containers which hold and dispense drinking water, to be efficiently and safely sterilized. There are certain devices that have been developed which employ the use of ozone gas (O₃) to sterilize water. These currently-available devices, however, suffer from one or more drawbacks. For example, the currently-available devices are typically unable to clean and sterilize bacteria that colonize in the space of above the water level within a water cooler (i.e., the currently-available devices are only able to sterilize the actual water, but not other internal parts of the water tank). The internal area of a water cooler, which exists above the water level, is often the most prone to bacterial colonization. Indeed, the often warm and humid environment that exists on the interior surface of most prior art water coolers is ideal for bacterial growth. The currently-available water coolers are often unable to effectively maintain such area in a sterile condition. In addition, it has been found that some currently-available sterilization methods leave unsafe levels of residual ozone in the drinking water, which can impart an undesirable taste to the drinking water (and, furthermore, can be hazardous to a person's health).

As the following will demonstrate, many of the foregoing problems with currently-available sterilization devices and methods for water coolers are addressed by the present invention.

### SUMMARY OF THE INVENTION

According to certain aspects of the invention, water coolers are provided that include devices for sterilizing the interior portions of such coolers and the water contained therein. For example, in certain embodiments, the bottled water coolers of the present invention comprise a water bottle, a cabinet, a cold tank, a bottle receptacle located in the bottom half of the cabinet, and an ozone generator, which is housed within the cabinet. The ozone generator is capable of dispensing ozone gas within a space located above a volume of water contained in the cold tank, such that the ozone gas will be effective to sterilize the interior portions of the cold tank. According to further aspects of the invention, the ozone generator is capable of dispensing ozone gas within the volume of water contained in the cold tank, preferably through an ozone diffuser located within the water, such as at the bottom of the cold tank. According to such embodiments, the ozone diffuser may be comprised of a porous stone or sintered metal.

According to additional aspects of the present invention, the bottled water coolers of the present invention comprise a water bottle, a cabinet, a cold tank, a bottle receptacle located in the bottom half of the cabinet, and an ozone generator, which is housed within the cabinet. In these embodiments, the ozone generator is capable of dispensing ozone gas within a space located above a volume of water contained in the water bottle, such that the ozone gas will be effective to sterilize the interior portions of the water bottle. Similar to the embodiments above, which provide ozone gas to the cold tank of the water cooler, the ozone generator may also be capable of dispensing ozone gas within the volume of water contained within the water bottle itself, preferably through an ozone diffuser located within the water, such as at the bottom of the water bottle.

According to yet further aspects of the present invention, methods of sterilizing the internal surfaces of water coolers, and the water contained therein, are provided. The methods of the present invention generally encompass, for example, the use and operation of the water coolers and devices associated therewith, as described in the present application. More particularly, the methods generally comprise providing an interior portion of a water cooler, located above a water level, with a volume of ozone gas during defined intervals. Alternatively, as described herein, the methods may comprise periodically delivering ozone gas into the volume of water contained within the cold tank and/or water bottle of the water cooler, vis-à-vis the ozone diffuser described herein.

The above-mentioned and additional features of the present invention are further illustrated in the Detailed Description contained herein.

### BRIEF DESCRIPTION OF THE FIGURES

FIG. 1: A cross-sectional, side view of an exemplary bottom-loading water cooler of the present invention, which employs an ozone generator that is connected to an air pump to sterilize the interior surfaces of the water cooler described herein.

FIG. 2: Another cross-sectional, side view of a portion of the water cooler shown in FIG. 1.

FIG. 3: A cross-sectional, side view of an exemplary bottom-loading water cooler of the present invention, which employs an ozone generator that is connected to a water reservoir/cold tank to sterilize the interior surfaces of the water cooler described herein (with the water cooler employing an air pump to push water through the water cooler).

FIG. 4: Another cross-sectional, side view of a portion of the water cooler shown in FIG. 3.

FIG. 5: A cross-sectional, side view of an exemplary bottom-loading water cooler of the present invention, which employs an ozone generator that is connected to a water reservoir/cold tank to sterilize the interior surfaces of the water cooler described herein (with the water cooler employing a water pump to push water through the water cooler).

FIG. 6: Another cross-sectional, side view of a portion of the water cooler shown in FIG. 5.

FIG. 7: A diagram that illustrates ozone being provided above the water level in the water reservoir/cold tank.

FIG. 8: A diagram that illustrates ozone being provided below the water level in the water reservoir/cold tank.

FIG. 9: A diagram that illustrates ozone being provided above the water level in the water bottle.

FIG. 10: Another diagram that illustrates ozone being provided above the water level in the water bottle.

FIG. 11: A diagram that illustrates ozone being provided below the water level in the water bottle.

### DETAILED DESCRIPTION OF THE INVENTION

The following will describe in detail several preferred embodiments of the present invention. These embodiments are provided by way of explanation only, and thus, should not unduly restrict the scope of the invention. In fact, those of ordinary skill in the art will appreciate upon reading the present specification and viewing the present drawings that the invention teaches many variations and modifications, and that numerous variations of the invention may be employed, used and made without departing from the scope and spirit of the invention.

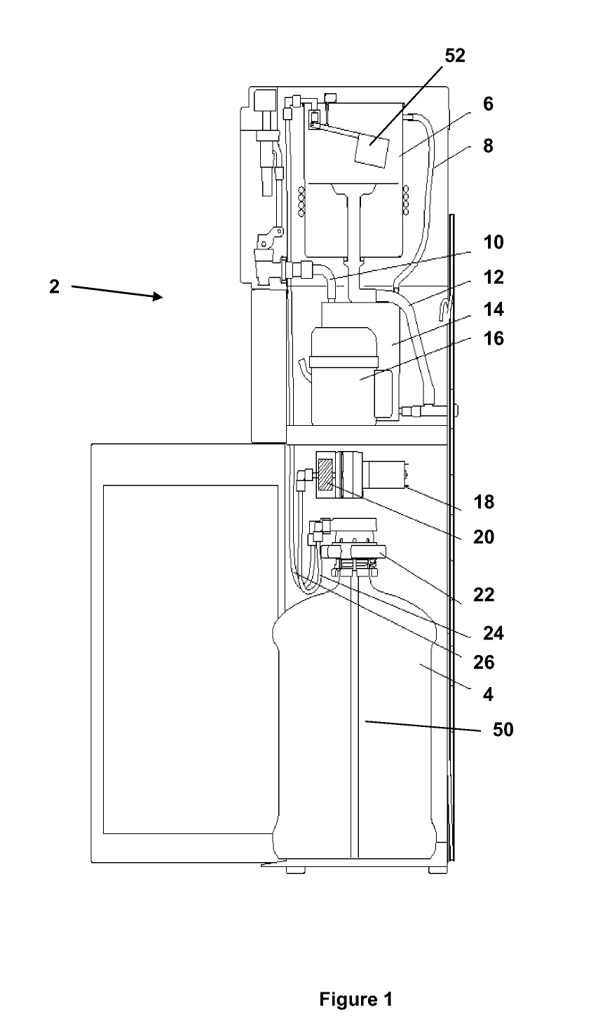

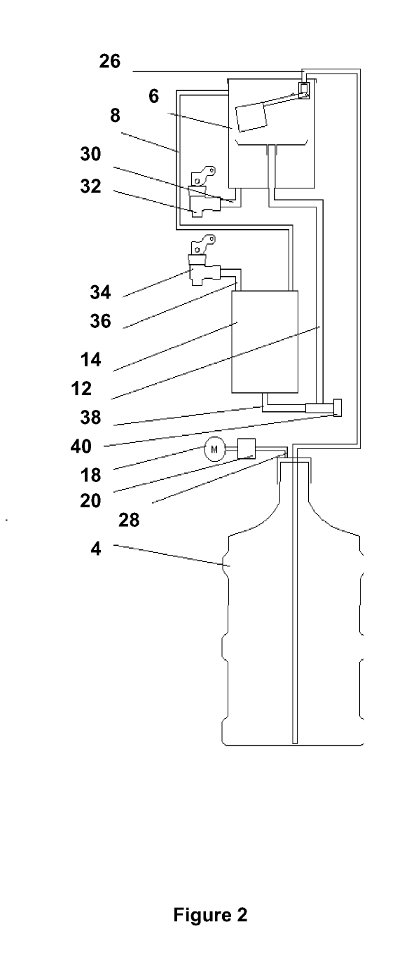

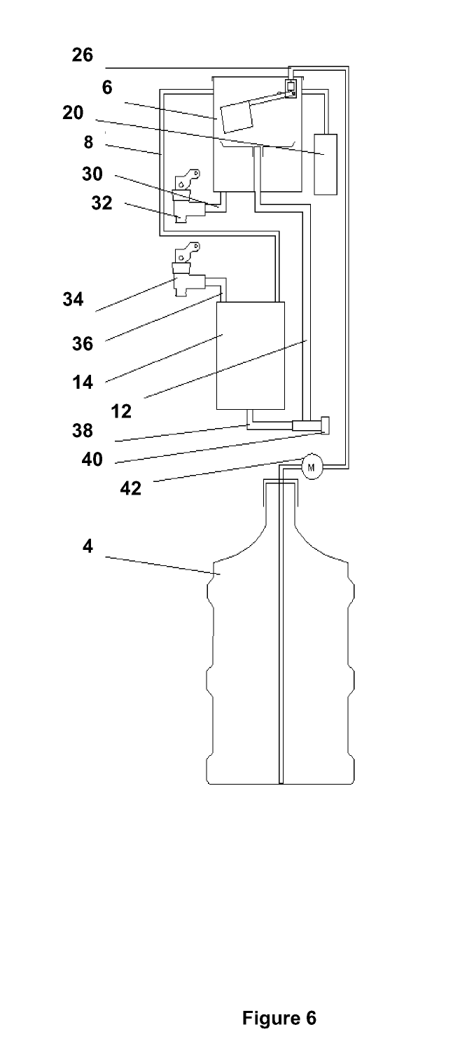

Referring to FIGS. 1-11, according to certain embodiments of the present invention, a water cooler is provided that includes a cabinet 2 and a water bottle 4, with the water bottle 4 being positioned within the bottom half of the cabinet 2. More particularly, a bottle receptacle (a platform) is located in a bottom half of the cabinet 2 that is configured to receive the water bottle 4 in an upright position. The cabinet 2 of the water cooler preferably comprises four sides, and is configured to house the water bottle 4 (in the lower half of the cabinet 2) and many of the other components described herein.

The water coolers of the present invention further include a cold tank/water reservoir 6, which is configured to hold a certain volume of water prior to being dispensed from the water cooler. The cold tank/water reservoir 6 will preferably include a float 52 disposed therein. The float 52 will comprise a buoyant object that is capable of floating on the top surface of the water that is contained in the cold tank/water reservoir 6. The float 52 may further comprise an arm that is pivotally connected to an axis, which allows the float 52 to move up-and-down as the volume of water in the cold tank/water reservoir 6 increases and decreases. The invention provides that when the float 52 is allowed to travel a certain distance toward the bottom surface of the cold tank/water reservoir 6 (i.e., when the water volume drops below a threshold level), a controller or switch will communicate to the air pump 18 or water pump 42 to activate and cause more water to be extracted from the water bottle 4 and to backfill into the cold tank/water reservoir 6. Conversely, when the float 52 is allowed to travel a certain distance toward the top surface of the cold tank/water reservoir 6 (i.e., when the water volume increases beyond a threshold level), a controller or switch will communicate to the air pump 18 or water pump 42 to de-activate, and to stop causing more water to backfill into the cold tank/water reservoir 6.

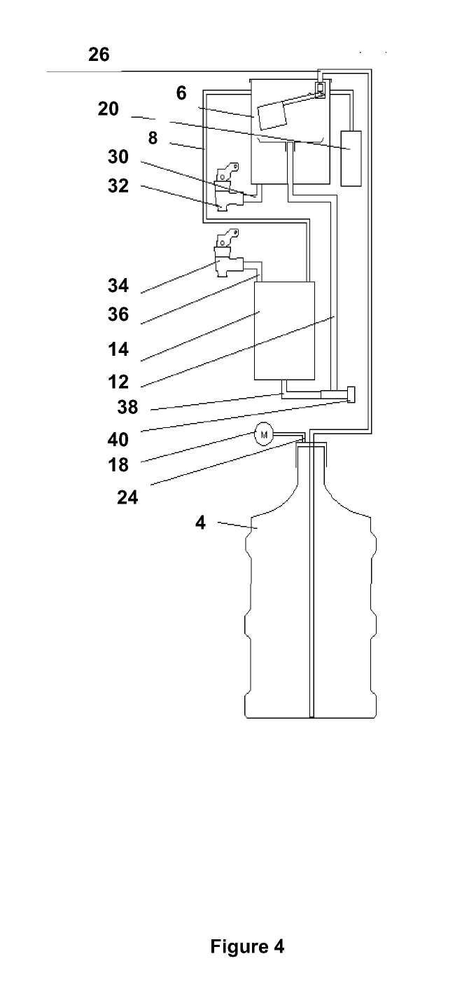

The cold tank/water reservoir 6 will preferably further comprise a means for cooling or chilling the water contained therein, such as by incorporating the use of heat sinks (evaporators) or circulating coolants (refrigerant gasses) along the surfaces thereof, which may require the use of a compressor 16. A non-limiting example of such a refrigerant gas includes 134a (tetrafluoroethane). The cold water contained therein may be dispensed from the water cooler by activating a cold water tap 32, which causes water to flow from the cold tank/water reservoir 6, through the cold water outlet tube 30, and out of the cold water tap 32 (FIG. 4). The cold water tap 32 will be accessible from outside of the cabinet 2.

The water coolers of the present invention further include an ozone generator 20, which is configured to generate ozone gas (O₃) for delivery to certain components of the water cooler described herein. More particularly, the invention provides that the ozone generator 20 will be configured to produce ozone gas at a concentration that is effective to kill, or reduce the viable number of, bacteria and/or other microbes that may colonize on the components of the water cooler described herein. The invention provides that the ozone output may be modulated, either by the end user (or by the manufacturer of the water cooler).

The present invention encompasses several embodiments of the water cooler described herein. More particularly, referring to FIGS. 1-2 and 9-11, an exemplary bottom loading water cooler of the present invention is shown, which employs an ozone generator 20 that is located near the neck portion of the water bottle 4. In such embodiments, the ozone generator 20 may be fluidly coupled to an air pump 18 (as shown in FIGS. 1, 2 and 9). According to such embodiments, the ozone generator 20 is configured to deliver ozone gas directly into the air flow that is generated by the air pump 18, which is then provided to and forced into the water bottle 4 via an air tube 24. The invention provides that a probe seal 22 may be affixed to the top neck portion of the water bottle 4. The probe seal 22 will preferably apply a water- and air-tight seal to the neck portion of the water bottle 4, and may include a probe seal tube 50 that is disposed into and terminates near the bottom surface of the water bottle 4, with the tube 50 housing a first channel that is configured to deliver, for example, air generated by the air pump 18, and a return second channel that is configured to extract water from the water bottle 4, and deliver the water to the water reservoir/cold tank 6 (via the water tube 26).

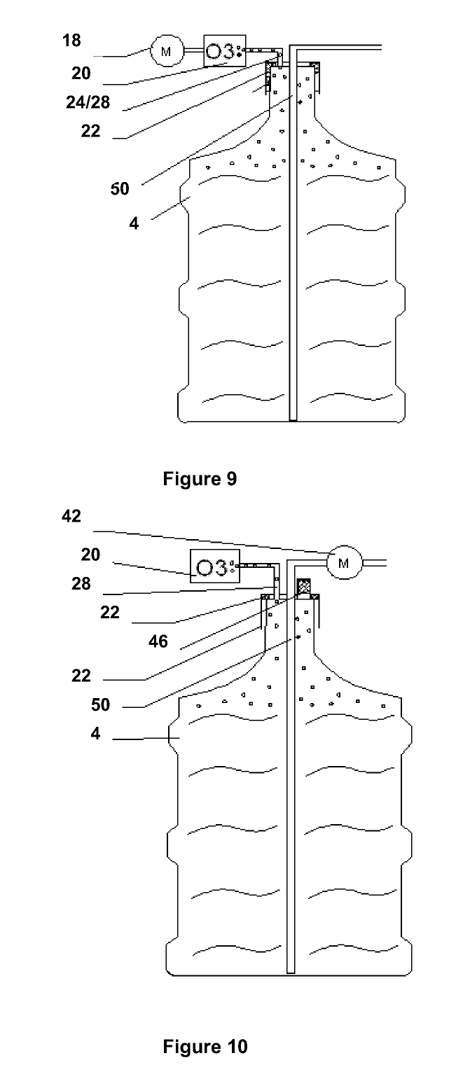

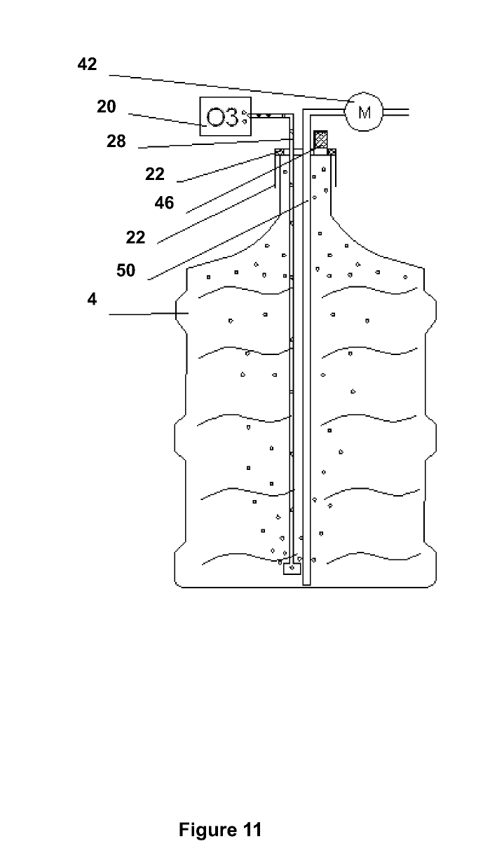

In other embodiments, as shown in FIGS. 10 and 11, a water pump 42 is used to extract water from the water bottle 4, with the ozone generator 20 delivering ozone gas to the water bottle 4 through a separate ozone tube 28. In such embodiments, the ozone generator 20 may deliver ozone gas to the top portion of the water bottle 4 (i.e., between the top surface of the water and the top interior surface of the water bottle 4) through a separate ozone tube 28 that terminates at the top of the water bottle 4 (FIG. 10). In other embodiments, the ozone generator 20 may deliver ozone gas to the bottom portion of the water bottle 4 (i.e., within the water contained therein) through a ozone tube 28 that terminates at the bottom of the water bottle 4, with the ozone gas optionally being dispensed from an ozone diffuser 54 located at the end of the ozone tube 28 (FIG. 11), such that the ozone gas will bubble and rise to the top of the water bottle 4. In this embodiment, both the interior surface of the water bottle 4, and the water contained therein, will benefit from the sterilization effects of the ozone gas. The ozone diffuser 54 may be comprised, for example, of porous stone or porous sintered metal. In such embodiments, the ozone gas is delivered to the interior portion of the water bottle 4 in order to sterilize the interior surfaces thereof (and the water contained therein), as illustrated in FIGS. 9-11.

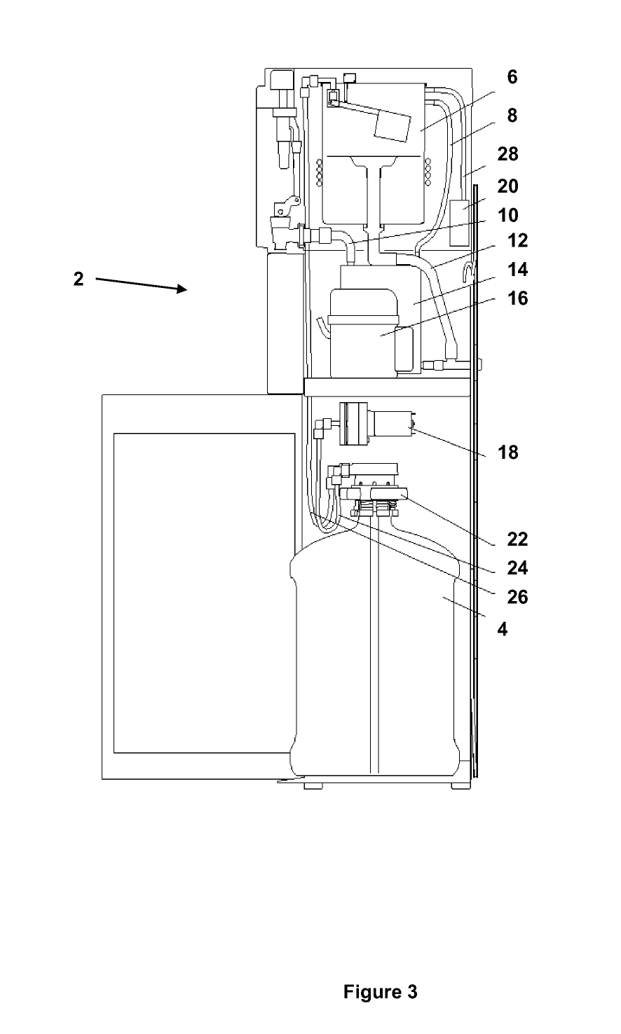

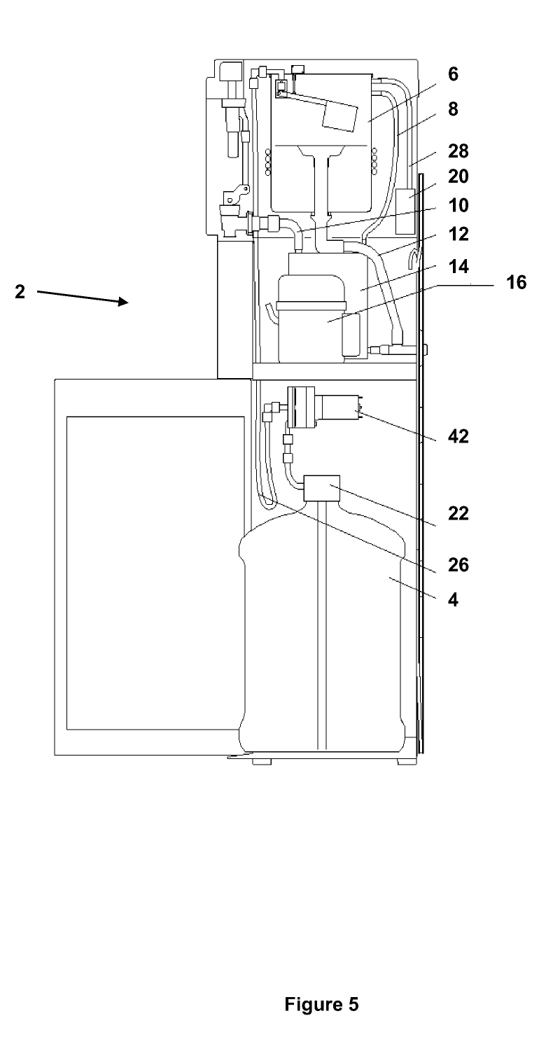

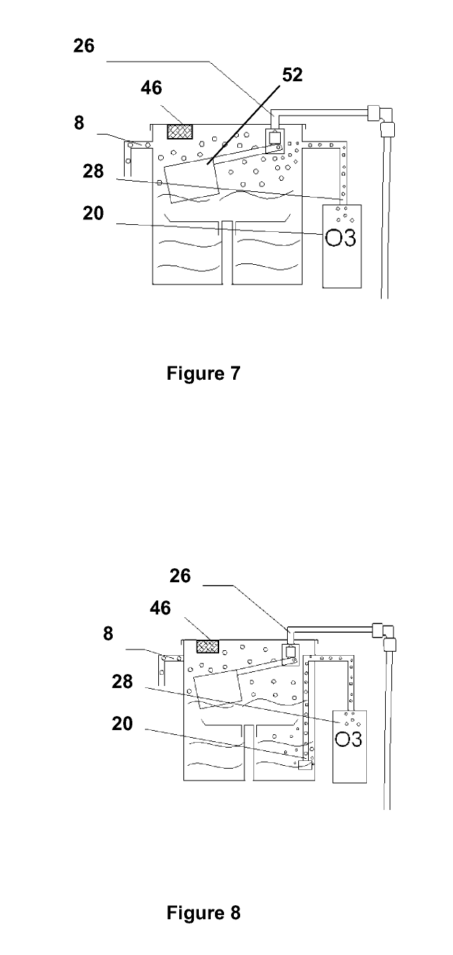

According to additional embodiments of the invention, the ozone generator 20 may be positioned in close proximity to the cold tank/water reservoir 6, as illustrated in FIGS. 3-8. According to these embodiments, the invention provides that water may be forced out of the water bottle 4 via an air pump 18 (FIG. 3) or water pump 42 (FIG. 5). According to such embodiments, the ozone generator 20 may deliver the ozone gas, through an ozone tube 28, into the interior of the cold tank/water reservoir 6, in an area located between the water surface and the top of the cold tank/water reservoir 6, as shown in FIG. 7. In other embodiments, the ozone generator 20 may deliver the ozone gas, through an ozone tube 28, to the interior of the cold tank/water reservoir 6, in an area located near the bottom thereof, and under the water surface, such that the ozone gas will bubble through the water and rise to the top of the cold tank/water reservoir 6, as shown in FIG. 8. In this embodiment, the ozone tube 28 may, optionally, be equipped with an ozone diffuser 54 located at the end of the ozone tube 28. In these embodiments, the ozone gas is delivered to the interior portion of the cold tank/water reservoir 6 in order to sterilize the interior surfaces thereof. More specifically, the invention provides that the ozone gas, following its release into the cold tank 6 (and/or water bottle 4 as described above) will form a type of ozone-shield, which will prevent bacterial growth on the susceptible interior portions of the cold tank 6 and/or water bottle 4 above the water level, as well as the other plastic and silicon parts that may exist close to the interface of the water level, valves, dispensing spigots, and other internal parts of the water cooler that make contact with the ozone gas.

According to certain embodiments, the water coolers may be equipped with an ozone generator 20 located in both positions described above. More particularly, the invention further encompasses a water cooler that is equipped with (1) an ozone generator 20 that is located near the neck portion of the water bottle 4 (to deliver ozone gas to the interior of the water bottle 4) and (2) an ozone generator 20 positioned in close proximity to the cold tank/water reservoir 6, as illustrated in FIGS. 3-8 (to deliver ozone gas to the cold tank/water reservoir 6). Still further, according to certain alternative embodiments, the water coolers may have only one of the two ozone generators 20, but will include a set of ozone tubes that are configured to deliver ozone gas from a single ozone generator 20 to both the interior portion of the cold tank/water reservoir 6 and water bottle 4.

The invention provides that the ozone gas, once dispensed into the cold tank 6 and/or water bottle 4, will break down over time. Accordingly, in order to avoid bacterial growth within the cold tank 6 and/or water bottle 4, the ozone generator 20 may comprise a programmable regulator which may be programmed to dispense ozone into the cold tank 6 and/or water bottle 4 at defined time points. For example, by way of illustration and not limitation, the ozone generator 20 may comprise a timer, which releases ozone into the cold tank 6 and/or water bottle 4 for a specific duration of time and at defined time points, e.g., ozone may be dispensed for 4 seconds every 2 hours, for 4 seconds every 4 hours, for 6 seconds every 4 hours, or any other variation desired. Alternatively, the invention provides that the ozone generator 20 may be programmed to dispense ozone into the cold tank 6 and/or water bottle 4 at defined time points, with the time points being defined by the manufacturer (which may not be modified by the end user). According to these embodiments, the manufacturer will be able to determine the appropriate amount of ozone gas to inject into the water cooler, at the specified time points, such that the end user will not be required to make any adjustments (and otherwise deviate from a protocol that the manufacturer has determined to be effective given the configuration and volume of the water cooler, and the concentration of ozone dispensed).

The water coolers of the present invention comprise other components that are needed to hold and dispense clean drinking water, including both cold water and hot water. More specifically, for example, the water coolers may include a hot water tank 14 that is configured to hold and heat a volume of water that is provided, directly or indirectly, from the water bottle 4. For example, referring to FIG. 1, the water coolers may include a water tube 26 that carries water from the water bottle 4 and into the water reservoir/cold tank 6. The invention provides that a hot water inlet tube 12 will connect the reservoir/cold tank 6 to the hot water tank 14 (where a controlled amount of water may be heated). The invention provides that controls may be employed to provide the hot water tank 14 with water from the cold tank 6 if, and only if, there is sufficient space available in the hot water tank 14. The hot water may then be dispensed from the hot water tank 14 via a hot water outlet tube 10, and out of the hot water tap 34 (which will be accessible from outside of the cabinet 2). This hot water assembly may further include a hot water inlet drain 38 and associated cap 40, which may be used to capture and optionally release excessive hot water that is stored therein. The assembly may also include a hot air vent tube 8, which is configured to vent and transfer excessive hot air and steam from the hot water inlet tube 12 and back into the water reservoir/cold tank 6.

The invention provides that the bottled water cooler may optionally further comprise an exhaust filter 46 that is capable of collecting, sequestering and/or neutralizing ozone gas from air that exits the water cooler (to avoid its release into the surrounding air). According to such embodiments, the exhaust filter 46 may comprise activated carbon (or foam saturated with activated carbon). Still more specifically, the exhaust filter 46 may comprise a one-way valve, which is adapted to allow air to escape from the cold tank 6 (or water bottle 4) when water is dispensed therefrom, with the one-way valve being fluidly coupled with the filter 46. As illustrated in FIGS. 7 and 8, the exhaust filter 46 may located within the top surface of the water reservoir/cold tank 6. In addition (or alternatively), as illustrated in FIGS. 10 and 11, the exhaust filter 46 may located within the top neck portion of the water bottle 4.

According to yet further aspects of the present invention, methods of sterilizing the internal surfaces of water coolers, and the water contained therein, are provided. The methods of the present invention encompass, for example, the use and operation of the water coolers and devices associated therewith, as described in the present application. More particularly, the methods generally comprise providing an interior portion of a water cooler, located above a water level, with a volume of ozone gas during defined intervals. Alternatively, as described above, the methods may comprise periodically delivering ozone gas into the volume of water contained within the cold tank (and/or water bottle) of the water cooler, vis-à-vis the ozone diffuser described herein.

The benefits of the water cooler designs and methods of water cooler sterilization described herein, are that the internally installed ozone generator will be effective to not only sterilize the cold tank water in certain embodiments, but also the interior water tank surfaces located above the water level. Furthermore, the water coolers and methods described herein improve drinking water hygiene by reducing the amount of ozone gas provided to the drinking water (or at least reducing ozone content below hazardous levels), while effectively sterilizing the drinking water and the critical surfaces and components of the water cooler.

The many aspects and benefits of the invention are apparent from the detailed description, and thus, it is intended for the following claims to cover all such aspects and benefits of the invention which fall within the scope and spirit of the invention. In addition, because numerous modifications and variations will be obvious and readily occur to those skilled in the art, the claims should not be construed to limit the invention to the exact construction and operation illustrated and described herein. Accordingly, all suitable modifications and equivalents should be understood to fall within the scope of the invention as claimed herein.

What is claimed is:

1. A bottled water cooler, which comprises:
(a) a water bottle;
(b) a cabinet;
(c) a bottle receptacle located in a bottom half of the cabinet that is configured to receive the water bottle; and
(d) an ozone generator, which is capable of dispensing ozone gas within a space located above a volume of water contained in the water bottle, wherein the ozone gas is effective to sterilize said space and interior portions of the water bottle located above said volume of water.

2. The bottled water cooler of claim 1, wherein (a) the ozone generator is fluidly coupled to an air pump and (b) the water cooler further comprises an ozone tube through which the ozone generator dispenses the ozone gas into said space located above the volume of water contained in the water bottle.

3. The bottled water cooler of claim 2, wherein the ozone generator and air pump dispense ozone gas directly into the space located above the volume of water.

4. The bottled water cooler of claim 3, wherein the ozone generator dispenses ozone gas into the space located above the volume of water at defined time intervals.

5. The bottled water cooler of claim 4, wherein the water bottle further comprises an exhaust filter that includes a one-way valve and an activated carbon material, wherein the activated carbon material is capable of sequestering or neutralizing ozone gas that escapes the water bottle through said exhaust filter.

6. The bottled water cooler of claim 1, wherein (a) the ozone generator is fluidly coupled to an air pump and (b) the water cooler further comprises an ozone tube through which the ozone generator dispenses the ozone gas into the volume of water contained in the water bottle, with a terminal end of the ozone tube being submerged in the volume of water.

7. The bottled water cooler of claim 6, which further comprises an ozone diffuser that is positioned within the volume of water contained within the water bottle, wherein the ozone diffuser is fluidly coupled to the terminal end of the ozone tube.

8. The bottled water cooler of claim 7, wherein the ozone generator dispenses ozone into the volume of water at defined time intervals.

9. The bottled water cooler of claim 8, wherein the water bottle further comprises an exhaust filter that includes a one-way valve and an activated carbon material, wherein the activated carbon material is capable of sequestering or neutralizing ozone gas that escapes the water bottle through said exhaust filter.

10. A bottled water cooler, which comprises:
(a) a water bottle;
(b) a cabinet;
(c) a cold tank;
(d) a bottle receptacle located in a bottom half of the cabinet that is configured to receive the water bottle; and
(e) an ozone generator, which is capable of dispensing ozone gas within a space located above a volume of water contained in the cold tank, wherein the ozone gas is effective to sterilize said space and interior portions of the cold tank located above said volume of water.

11. The bottled water cooler of claim 10, wherein the ozone generator dispenses ozone gas directly into the space located above the volume of water.

12. The bottled water cooler of claim 11, wherein the ozone generator dispenses ozone gas into the space located above the volume of water at defined time intervals.

13. The bottled water cooler of claim 12, wherein the water bottle further comprises an exhaust filter that includes a one-way valve and an activated carbon material, wherein the activated carbon material is capable of sequestering or neutralizing ozone gas that escapes the cold tank through said exhaust filter.

14. The bottled water cooler of claim 10, wherein the ozone generator dispenses the ozone gas into the volume of water contained in the cold tank, through a terminal end of an ozone tube which is submerged in the volume of water.

15. The bottled water cooler of claim 14, which further comprises an ozone diffuser that is positioned within the volume of water contained within the cold tank, wherein the ozone diffuser is fluidly coupled to the terminal end of the ozone tube.

16. The bottled water cooler of claim 15, wherein the ozone generator dispenses ozone into the volume of water at defined time intervals.

17. The bottled water cooler of claim 16, wherein the cold tank further comprises an exhaust filter that includes a one-way valve and an activated carbon material, wherein the activated carbon material is capable of sequestering or neutralizing ozone gas that escapes the cold tank through said exhaust filter.
